(19) United States
(12) Patent Application Publication
(10) Pub. No.: US 2016/0139032 A1
(43) Pub. Date: May 19, 2016

(54) INSPECTION SYSTEM AND METHOD USING AN OFF-AXIS UNOBSCURED OBJECTIVE LENS

(71) Applicant: KLA-Tencor Corporation, Milpitas, CA (US)

(72) Inventors: Claudio Rampoldi, Mountain View, CA (US); Barry Blasenheim, San Jose, CA (US); Alexander Kuznetsov, Mountain View, CA (US); Shankar Krishnan, Santa Clara, CA (US); Andrei V. Shchegrov, Los Gatos, CA (US)

(21) Appl. No.: 14/668,879

(22) Filed: Mar. 25, 2015

Related U.S. Application Data
(60) Provisional application No. 62/082,008, filed on Nov. 19, 2014.

(51) Int. Cl. G01N 21/21; G01N 21/55; G01N 21/47

(52) U.S. Cl. CPC G01N 21/211; G01N 21/47; G01N 21/55; G01N 2021/213; G01N 2201/06113; G01N 2201/08

(57) ABSTRACT

An inspection system is provided that can include a reflectometer having a light source for projecting light, and a light splitter for receiving the light projected by the light source, transforming at least one aspect of the light, and projecting the light once transformed. The reflectometer further has an off-axis unobscured objective lens through which the light transformed by the light splitter passes to contact a fabricated component, and has a detector for detecting a result of the transformed light contacting the fabricated component. The inspection system can additionally, or alternatively, include an ellipsometer having a light source similar to the reflectometer, and further a polarizing element to polarize the light of the light splitter. The polarized light passes through an off-axis unobscured objective lens to contact a fabricated component, and a detector detects a result of the polarized light contacting the fabricated component.

### RELATED APPLICATION(S)

This application claims the benefit of U.S. Provisional Patent Application No. 62/082,008 filed Nov. 19, 2014, the entire contents of which are incorporated herein by reference.

### FIELD OF THE INVENTION

The present invention relates to inspection systems, and more particularly to inspections systems having an objective lens.

### BACKGROUND

Currently, there are various types of inspection systems having optical components, and specifically having an objective lens. These inspection systems are generally used for inspecting a target component. For example, metrology, which is one form of inspection, generally involves measuring various physical features of a fabricated component. In the case of semiconductor metrology tools, structural and material characteristics (e.g. material composition, dimensional characteristics of structures and films such as film thickness and/or critical dimensions of structures, overlay, etc.) associated with various semiconductor fabrication processes can be measured using semiconductor metrology tools. Once a measurement is obtained using a metrology tool, the measurement may be analyzed for various purposes, such as to determine whether it is abnormal.

To date, metrology tools have, in their most basic form, included a light source for projecting light onto a light splitter, from which the light is then projected onto a fabricated component through an objective lens. Of course, in more specific implementations metrology tools can have additional elements. In any case, these metrology tools have exhibited various limitations due to the type of objective lens utilized.

For example, in one implementation metrology tools have utilized an objective lens made of refractive elements. However, due to the completely or predominately refractive nature of its optical elements, such a tool has only been able to cover a small spectral range and have only been able to achieve spot (measurement box) sizes of 25 um or larger.

In another implementation metrology tools have utilized a Schwarzschild objective lens which allows for a broader spectral range and spot sizes smaller than 20 um, but which block the center portion of the light from reaching the fabricated semiconductor component and which typically operate at high numerical apertures (i.e. the rays have large incidence angles on the fabricated semiconductor component). For these reasons such a tool would be unsuitable for normal incidence operation, which combined with the large incidence rays would preclude computational simplification and speedup, requiring in the end longer computation times. The computational speedup refers to an electromagnetic equation solver that can be optimized for speed when numerical aperture is not large (and single angle of incidence (AOI) can be computed) and AOI is normal, in which case various considerations of system symmetry can be taken advantage of. An additional drawback of this type of tool is the relatively lower image quality that can be expected if, for example, the tool needs to perform pattern recognition functions used for sample alignment and navigation.

Other types of inspection systems may have similar limitations. There is thus a need for addressing these and/or other issues associated with the prior art implementations of inspection systems.

### SUMMARY

An inspection system and method that use an off-axis unobscured objective lens are provided. The inspection system, in one embodiment, includes a reflectometer having a light source for projecting light, and a light splitter for receiving the light projected by the light source, transforming at least one aspect of the light, and projecting the light once transformed. The reflectometer further has an off-axis unobscured objective lens through which the light transformed by the light splitter passes to contact a fabricated component, and has a detector for detecting a result of the transformed light contacting the fabricated component.

In another embodiment, the inspection system includes an ellipsometer having a light source for projecting light. The ellipsometer further has a polarizing element through which the light passes to polarize the transformed light, an off-axis unobscured objective lens through which the polarized light passes to contact a fabricated component, and a detector for detecting a result of the polarized light contacting the fabricated component.

### BRIEF DESCRIPTION OF THE DRAWINGS

FIG. 1 shows a schematic of an exemplary metrology tool, in accordance with the prior art.

FIG. 2 illustrates a reflectometer comprising an off-axis unobscured objective lens, in accordance with an embodiment.

FIG. 3 illustrates an infinite conjugate reflectometer comprising an off-axis unobscured objective lens and beam apodizer, in accordance with another embodiment.

FIG. 4 illustrates a finite conjugate reflectometer comprising an off-axis unobscured objective lens and beam apodizer, in accordance with another embodiment.

FIG. 5 illustrates a metrology system comprising an infinite conjugate reflectometer with a beam apodizer and off-axis unobscured objective lens for normal incidence, and an ellipsometer for oblique incidence, in accordance with yet another embodiment.

FIG. 6 illustrates a metrology system comprising a first infinite conjugate reflectometer with a beam apodizer and off-axis unobscured objective lens for normal incidence, and a second infinite conjugate reflectometer with an off-axis unobscured objective lens for oblique incidence, in accordance with still yet another embodiment.

FIG. 7 illustrates an ellipsometer comprising an off-axis unobscured objective lens, in accordance with an embodiment.

### DETAILED DESCRIPTION

In the field of semiconductor metrology, a metrology tool may comprise an illumination system which illuminates a target, a collection system which captures relevant information provided by the illumination system's interaction (or lack thereof) with a target, device or feature, and a processing system which analyzes the information collected using one or more algorithms. Metrology tools can be used to measure structural and material characteristics (e.g. material composition, dimensional characteristics of structures and films such as film thickness and/or critical dimensions of structures, overlay, etc.) associated with various semiconductor fabrication processes. These measurements are used to facilitate process controls and/or yield efficiencies in the manufacture of semiconductor dies.

The metrology tool can comprise one or more hardware configurations which may be used in conjunction with certain embodiments of this invention to, e.g., measure the various aforementioned semiconductor structural and material characteristics. Examples of such hardware configurations include, but are not limited to, the following.
Spectroscopic ellipsometer (SE)
SE with multiple angles of illumination
SE measuring Mueller matrix elements (e.g. using rotating compensator(s))
Single-wavelength ellipsometers
Beam profile ellipsometer (angle-resolved ellipsometer)
Beam profile reflectometer (angle-resolved reflectometer)
Broadband reflective spectrometer (spectroscopic reflectometer)
Single-wavelength reflectometer
Angle-resolved reflectometer
Imaging system
Scatterometer (e.g. speckle analyzer)

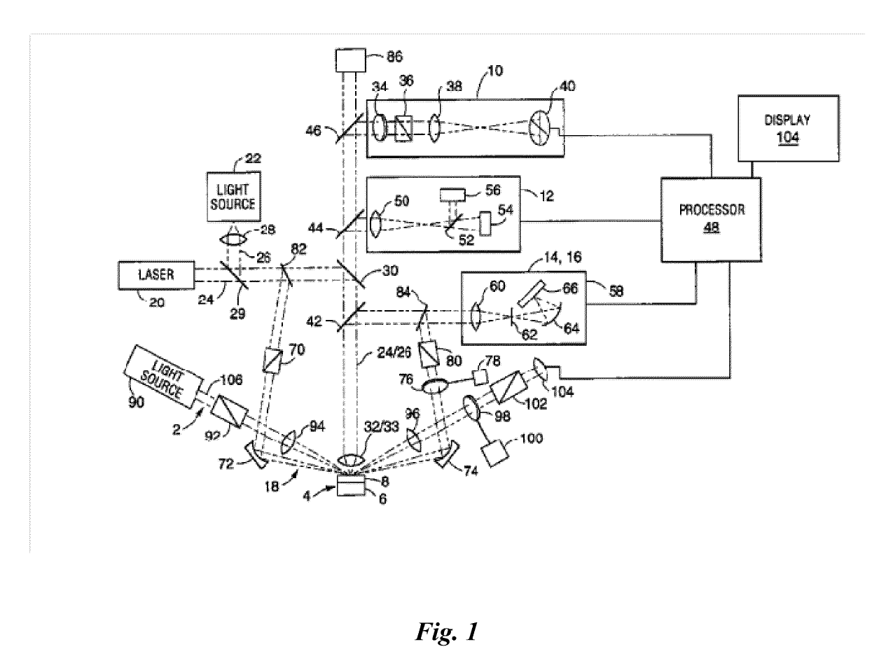

The hardware configurations can be separated into discrete operational systems. On the other hand, one or more hardware configurations can be combined into a single tool. One example of such a combination of multiple hardware configurations into a single tool is shown in FIG. 1, incorporated herein from U.S. Pat. No. 7,933,026 which is hereby incorporated by reference in its entirety for all purposes. FIG. 1 shows, for example, a schematic of an exemplary metrology tool that comprises: a) a broadband SE (i.e., 18); b) a SE (i.e., 2) with rotating compensator (i.e., 98); c) a beam profile ellipsometer (i.e., 10); d) a beam profile reflectometer (i.e., 12); e) a broadband reflective spectrometer (i.e., 14); and f) a deep ultra-violet reflective spectrometer (i.e., 16). In addition, there are typically numerous optical elements in such systems, including certain lenses, collimators, mirrors, quarter-wave plates, polarizers, detectors, cameras, apertures, and/or light sources. The wavelengths for optical systems can vary from about 120 nm to 3 microns. For non-ellipsometer systems, signals collected can be polarization-resolved or unpolarized. FIG. 1 provides an illustration of multiple metrology heads integrated on the same tool. However, in many cases, multiple metrology tools are used for measurements on a single or multiple metrology targets. This is described, for example, in U.S. Pat. No. 7,478,019, “Multiple tool and structure analysis,” which is also hereby incorporated by reference in its entirety for all purposes.

The illumination system of the certain hardware configurations includes one or more light sources. The light source may generate light having only one wavelength (i.e., monochromatic light), light having a number of discrete wavelengths (i.e., polychromatic light), light having multiple wavelengths (i.e., broadband light) and/or light the sweeps through wavelengths, either continuously or hopping between wavelengths (i.e. tunable sources or swept source). Examples of suitable light sources are: a white light source, an ultraviolet (UV) laser, an arc lamp or an electrode-less lamp, a laser sustained plasma (LSP) source, for example those commercially available from Energetiq Technology, Inc., Woburn, Mass., a super-continuum source (such as a broadband laser source) such as those commercially available from NKT Photonics Inc., Morganville, N.J., or shorter-wavelength sources such as x-ray sources, extreme UV sources, or some combination thereof. The light source may also be configured to provide light having sufficient brightness, which in some cases may be a brightness greater than about 1 W/(nm cm² Sr). The metrology system may also include a fast feedback to the light source for stabilizing its power and wavelength. Output of the light source can be delivered via free-space propagation, or in some cases delivered via optical fiber or light guide of any type.

The metrology tool is designed to make many different types of measurements related to semiconductor manufacturing. Certain embodiments may be applicable to such measurements. For example, in certain embodiments the tool may measure characteristics of one or more targets, such as critical dimensions, overlay, sidewall angles, film thicknesses, process-related parameters (e.g., focus and/or dose). The targets can include certain regions of interest that are periodic in nature, such as for example gratings in a memory die. Targets can include multiple layers (or films) whose thicknesses can be measured by the metrology tool. Targets can include target designs placed (or already existing) on the semiconductor wafer for use, e.g., with alignment and/or overlay registration operations. Certain targets can be located at various places on the semiconductor wafer. For example, targets can be located within the scribe lines (e.g., between dies) and/or located in the die itself. In certain embodiments, multiple targets are measured (at the same time or at differing times) by the same or multiple metrology tools as described in U.S. Pat. No. 7,478,019. The data from such measurements may be combined. Data from the metrology tool is used in the semiconductor manufacturing process for example to feed-forward, feed-backward and/or feed-sideways corrections to the process (e.g. lithography, etch) and therefore, might yield a complete process control solution.

As semiconductor device pattern dimensions continue to shrink, smaller metrology targets are often required. Furthermore, the measurement accuracy and matching to actual device characteristics increase the need for device-like targets as well as in-die and even on-device measurements. Various metrology implementations have been proposed to achieve that goal. For example, focused beam ellipsometry based on primarily reflective optics is one of them and described in the patent by Piwonka-Corle et al. (U.S. Pat. No. 5,608,526, “Focused beam spectroscopic ellipsometry method and system”). Apodizers can be used to mitigate the effects of optical diffraction causing the spread of the illumination spot beyond the size defined by geometric optics. The use of apodizers is described in the patent by Norton, U.S. Pat. No. 5,859,424, “Apodizing filter system useful for reducing spot size in optical measurements and other applications”. The use of high-numerical-aperture tools with simultaneous multiple angle-of-incidence illumination is another way to achieve small-target capability. This technique is described, e.g. in the patent by Opsal et al, U.S. Pat. No. 6,429,943, “Critical dimension analysis with simultaneous multiple angle of incidence measurements”.

Other measurement examples may include measuring the composition of one or more layers of the semiconductor stack, measuring certain defects on (or within) the wafer, and measuring the amount of photolithographic radiation exposed to the wafer. In some cases, metrology tool and algorithm may be configured for measuring non-periodic targets, see e.g. “The Finite Element Method for Full Wave Electromagnetic Simulations in CD Metrology Using Scatterometry” by P. Jiang et al (pending U.S. patent application Ser. No. 14/294,540, filed Jun. 3, 2014, attorney docket no. P0463) or “Method of electromagnetic modeling of finite structures and finite illumination for metrology and inspection” by A. Kuznetsov et al. (pending U.S. patent application Ser. No. 14/170,150, attorney docket no. P0482).

Measurement of parameters of interest usually involves a number of algorithms. For example, optical interaction of the incident beam with the sample is modeled using EM (electro-magnetic) solver and uses such algorithms as RCWA, FEM, method of moments, surface integral method, volume integral method, FDTD, and others. The target of interest is usually modeled (parameterized) using a geometric engine, or in some cases, process modeling engine or a combination of both. The use of process modeling is described in “Method for integrated use of model-based metrology and a process model,” by A. Kuznetsov et al. (pending U.S. patent application Ser. No. 14/107,850, attorney docket no. P4025). A geometric engine is implemented, for example, in AcuShape software product of KLA-Tencor.

Collected data can be analyzed by a number of data fitting and optimization techniques an technologies including libraries, Fast-reduced-order models; regression; machine-learning algorithms such as neural networks, support-vector machines (SVM); dimensionality-reduction algorithms such as, e.g., PCA (principal component analysis), ICA (independent component analysis), LLE (local-linear embedding); sparse representation such as Fourier or wavelet transform; Kalman filter; algorithms to promote matching from same or different tool types, and others.

Collected data can also be analyzed by algorithms that do not include modeling, optimization and/or fitting e.g. U.S. patent application Ser. No. 14/057,827.

Computational algorithms are usually optimized for metrology applications with one or more approaches being used such as design and implementation of computational hardware, parallelization, distribution of computation, load-balancing, multi-service support, dynamic load optimization, etc. Different implementations of algorithms can be done in firmware, software, FPGA, programmable optics components, etc.

The data analysis and fitting steps usually pursue one or more of the following goals:
Measurement of CD, SWA, shape, stress, composition, films, band-gap, electrical properties, focus/dose, overlay, generating process parameters (e.g., resist state, partial pressure, temperature, focusing model), and/or any combination thereof;
Modeling and/or design of metrology systems;
Modeling, design, and/or optimization of metrology targets.

The following description discloses embodiments of an inspection system and method that use an off-axis unobscured objective lens, which may be implemented in the context of the semiconductor metrology tool described above, or which may be implemented in the context of other inspection systems (e.g. wafer inspection, reticle inspection, etc.).

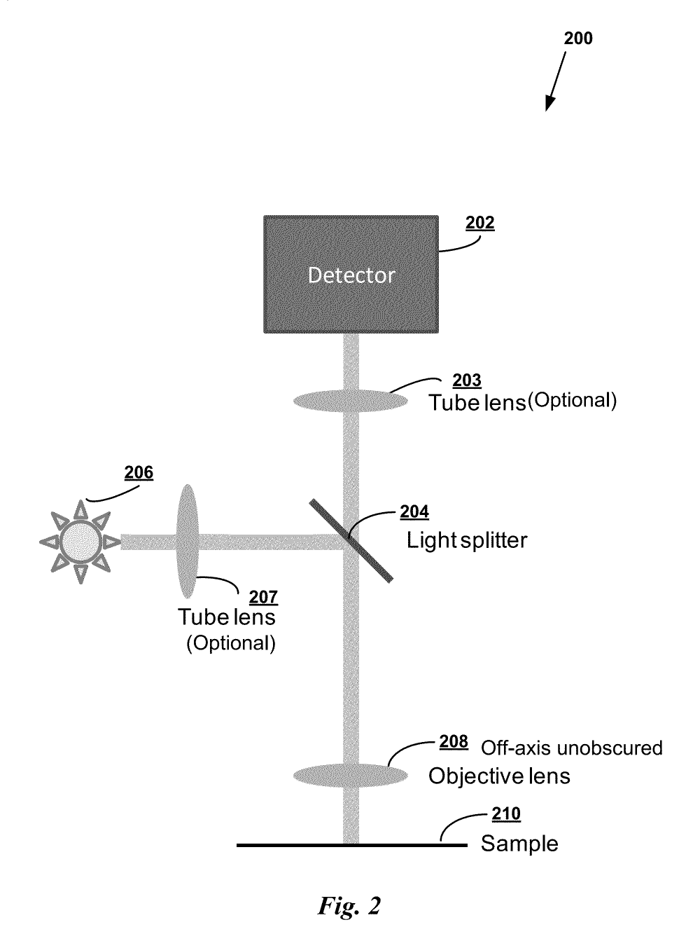

FIG. 2 illustrates a reflectometer 200, in accordance with an embodiment. As shown, the reflectometer 200 includes a light source 206 for projecting light (e.g. broadband light). The light source 206 may be an ultra-high-brightness light source, with deep-UV infra-red (DUV-IR) such as one or more of a laser-driven plasma source, a radio frequency (RF)-driven plasma source, a supercontinuum laser source, etc. For example, a plasma light source may be used to project light having shorter wavelengths (e.g. 190-1000 nm), while a supercontinuum laser light source may be used to project light having longer wavelengths (e.g. 400-2200 nm). Further, supercontinuum light source can enable a smaller measurement area (IR spot), described below, due to coherency. Of course, the light source 206 may also be of another type having lower brightness, such as Xe arc or D2 lamps if desired.

The reflectometer 200 additionally includes a light splitter 204 for receiving the light projected by the light source 206, transforming at least one aspect of the light, and projecting the light once transformed. In one embodiment, the light splitter 204 may be a beamsplitter. In another embodiment, the light splitter 204 may be a half mirror. In this way, the light splitter 204 can transform the light by splitting the light into two or more subparts.

As a further option, the light splitter 204 can transform the light by changing a direction of the light. For example, the light splitter 204 can receive the light and then project the same in a direction that provides normal incidence with a fabricated component 210 to which contact is to be made. In any case, the light splitter 204 is utilized to transform at least one aspect of the light and then project the transformed light toward an off-axis unobscured objective lens 208 described below.

Strictly as an option, the reflectometer 200 may include a tube lens 207 situated between the light source 206 and the light splitter 204 along the light path, and through which the light projected from the light source 206 passes to reach the light splitter 204. In one embodiment, the tube lens 207 may have an off-axis unobscured aspheric reflective configuration to minimize chromatic aberrations.

Further, the reflectometer 200 includes an off-axis unobscured objective lens 208 through which the transformed light passes to contact a fabricated component 210 (shown as sample). The off-axis unobscured objective lens 208 may further be aspheric. As noted above, the transformed light may pass through the off-axis unobscured objective lens 208 to contact the fabricated component 210 at a normal incidence.

As also shown, the reflectometer 200 includes a detector 202 for detecting a result of the transformed light contacting the fabricated component 210. The result may indicate whether or not the transformed light (or parts thereof) do in fact contact the fabricated component 210, or any other information related to contact between the transformed light and the fabricated component 210 (e.g. for inspection purposes). For example, the detector 202 may be a spectrometer which performs measurements based on information collected from the contact between the transformed light and the fabricated component 210, in which case the reflectometer 200 may be a spectroscopic reflectometer.

Optionally, the reflectometer 200 may include a tube lens 203 through which the detector 202 detects the result of contact between the transformed light and the fabricated component 210. As shown, this optional tube lens 203 may be situated between the detector 202 and the light splitter 204 along the light path, to pass any result of the contact between the transformed light and the fabricated component 210 through the tube lens 203. In one embodiment, the tube lens 203 may have an off-axis unobscured aspheric reflective configuration, similar to the tube lens 207 described above. In the situation where the reflectometer 200 includes the tube lenses 203 and 207, the reflectometer 200 may be an infinite-conjugate reflectometer 200. Without such tube lenses 203 and 207, the reflectometer 200 may be a finite-conjugate reflectometer 200.

To this end, in use, the reflectometer 200 described above may operate to: (1) project light from the light source 206, (2) receive the light projected by the light source 206 at the light splitter 204, (3) transform, by the light splitter 204, at least one aspect of the light, (4) project, by the light splitter 204, the light once transformed, (5) pass the transformed light through the off-axis unobscured objective lens 208 to contact the fabricated component 210, and (6) detect, by the detector 202, a result of the transformed light contacting the fabricated component 210. Of course, it should be noted that the sequence of these operations is not so limited, such as for example when the reflectometer 200 includes the tube lenses 203 and 207 along the light path.

In this way, as described above, the reflectometer 200 may comprise both high-brightness broadband light source(s), as well as off-axis unobscured aspheric reflective optics. By specifically configuring the reflectometer 200 to use the off-axis unobscured objective lens 208, the reflectometer 200 may enable achromatic metrology or other inspection on small targets, for example with broad wavelength (DUV to near-IR) and at normal incidence as described above. In one embodiment, an area of contact between the transformed light and the fabricated component may be 15 by 15 micron or smaller. Use of the off-axis unobscured objective lens 208 may further eliminate objective related chromatic aberration and may allow for optimal performance from the UV (<190 nm) to the IR (>2.5 um) while not requiring a central obscuration. The ability to measure at normal incidence without a central obscuration may provide computational data modeling simplifications that speedup time to results. Further, extension of the wavelength range from UV to IR using a single optical system to deliver light from the source and collection light to the detector enables signals in regions of high sensitivity for critical dimension (CD) and/or film structures that have low sensitivity in the Ultraviolet-visible spectroscopy (UV-VIS) spectrum.

As an option, due to its normal-incidence configuration, the reflectometer 200 may be co-located (both parcentral and parfocal) with an additional reflectometer and/or ellipsometer, which may have an oblique-incidence. Examples of these co-location embodiments are described in more detail below with respect to the subsequent figures. As another option, the reflectometer 200 may be a sensor used in an integrated optical metrology tool (i.e. it may be integrated into a metrology interface block making it compatible as an integrated metrology). Further, the reflectometer 200 may include an apodizer enabling small spot sizes that are 10 um or smaller (e.g. the area of contact between the transformed light and the fabricated component may be 10 by 10 micron or smaller). Examples of the incorporation of an apodizer into a reflectometer are described below with respect to the subsequent figures.

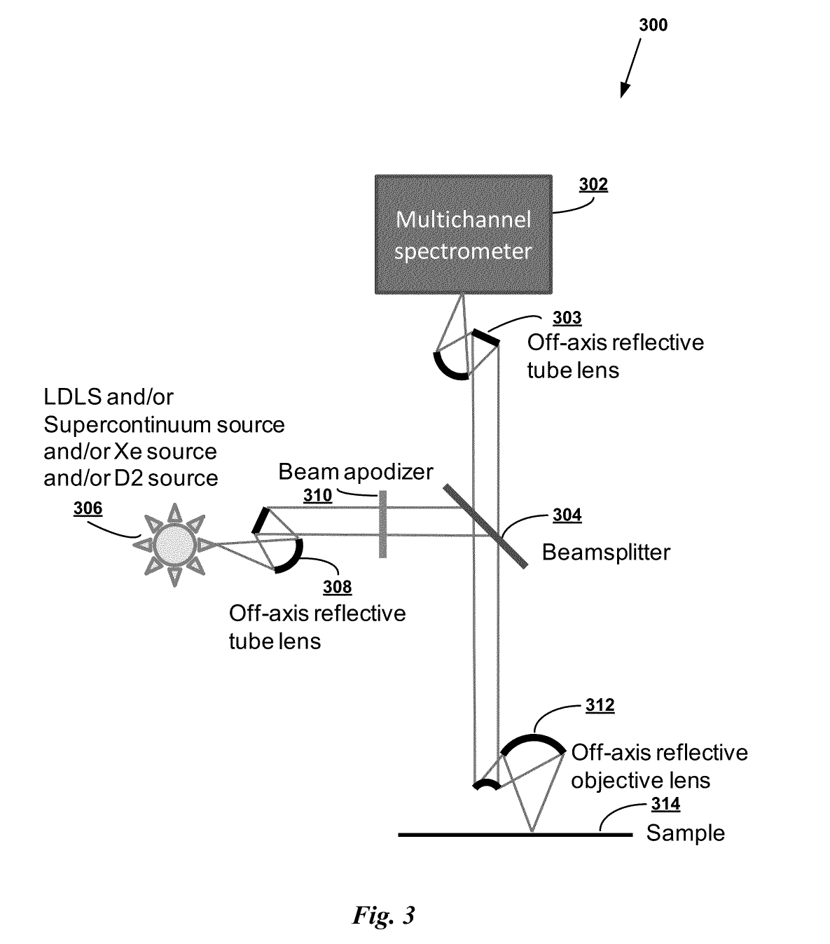

FIG. 3 illustrates an infinite conjugate reflectometer 300 comprising an off-axis unobscured objective lens and beam apodizer, in accordance with another embodiment. It should be noted that the definitions above may equally apply to the following description.

As shown, the infinite conjugate reflectometer 300 includes the ultra-high-brightness light source 306 and beamsplitter 304 with tube lens 308 situated therebetween, as described with respect to the reflectometer 200 of FIG. 2. The infinite conjugate reflectometer 300 also includes the off-axis unobscured objective lens 312 and spectrometer 302 with tube lens 303 situated therebetween, as described with respect to the reflectometer 200 of FIG. 2.

As further shown, the infinite conjugate reflectometer 300 includes a beam apodizer 310, which is an optional addition to the reflectometer 200 of FIG. 2. The beam apodizer 310 is situated between the tube lens 308 on the light source 306 side and the beamsplitter 304 to provide beam apodization of the light. Namely, the light projected from the light source 306 passes through the apodizer 310 to reach the beamsplitter 304. As shown, the apodized light is controlled by the infinite conjugate reflectometer 300 to make contact with the fabricated component 314.

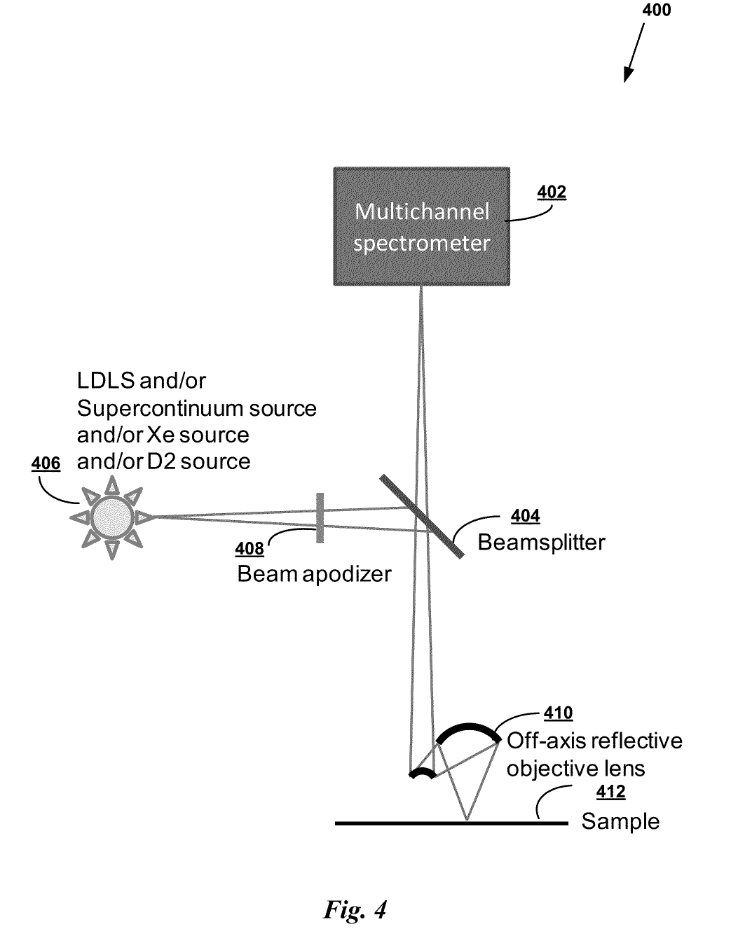

FIG. 4 illustrates a finite conjugate reflectometer 400 comprising an off-axis unobscured objective lens and beam apodizer, in accordance with another embodiment. Again, it should be noted that the definitions above may equally apply to the following description.

As shown, the finite conjugate reflectometer 400 includes the ultra-high-brightness light source 406 and beamsplitter 404, as described with respect to the reflectometer 200 of FIG. 2. The finite conjugate reflectometer 400 also includes the off-axis unobscured objective lens 410 and spectrometer 402, as described with respect to the reflectometer 200 of FIG. 2.

As further shown, the finite conjugate reflectometer 400 includes a beam apodizer 408, which is an optional addition to the reflectometer 200 of FIG. 2. The beam apodizer 408 is situated between the light source 406 and the beamsplitter 404 to provide beam apodization of the light. As shown, the apodized light is controlled by the finite conjugate reflectometer 400 to make contact with the fabricated component 412.

The use of achromatic optics with ultra-low aberrations, as mentioned with respect to the reflectometer 200 in FIG. 2, combined with beam apodization as shown in FIGS. 3 and 4, can enable the generation of <=10 um spot sizes at normal incidence. Thus, the reflectometers 300 and 400 shown in FIGS. 3 and 4 may be capable of obtaining a small spot size simultaneously with a low numerical aperture. Further, the use of normal incidence on the fabricated component, when combined with a constrained numerical aperture, enables computational simplification with subsequent analysis speedups within the spectrometer 302.

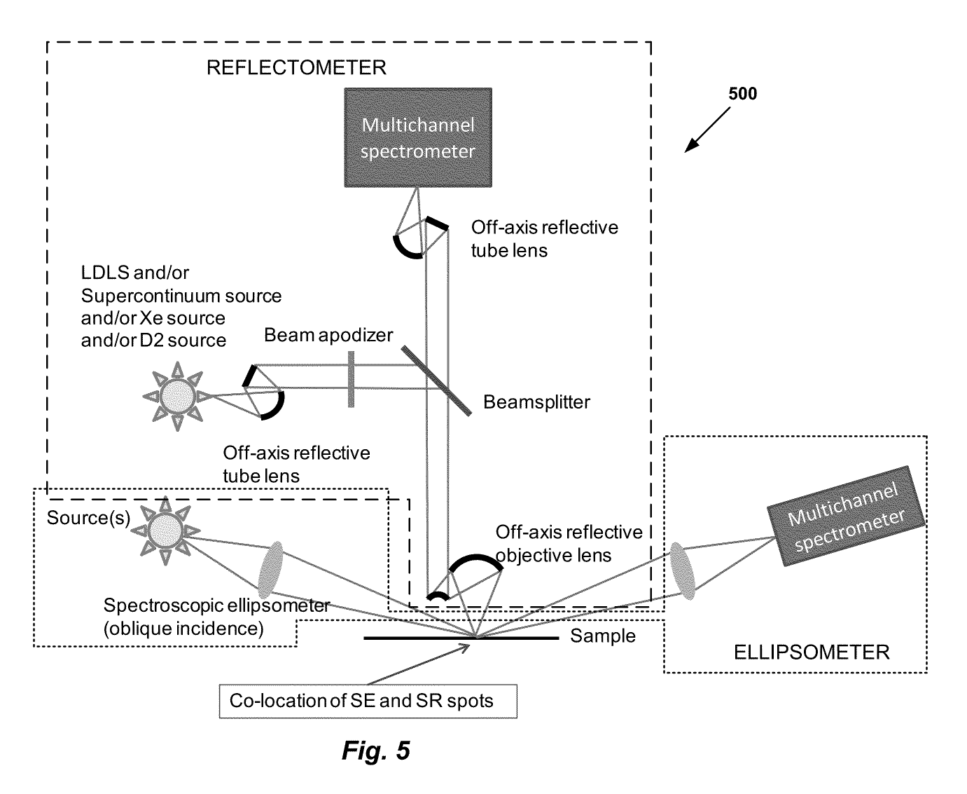

FIG. 5 illustrates a metrology system 500 comprising an infinite conjugate reflectometer with a beam apodizer and off-axis unobscured objective lens for normal incidence, and an ellipsometer for oblique incidence, in accordance with yet another embodiment. Yet again, it should be noted that the definitions above may equally apply to the following description.

The infinite conjugate reflectometer portion of the metrology system 500 is configured as described above with respect to FIG. 3 (or which may take any of the other configurations described above). Also included is an ellipsometer which is co-located with the reflectometer.

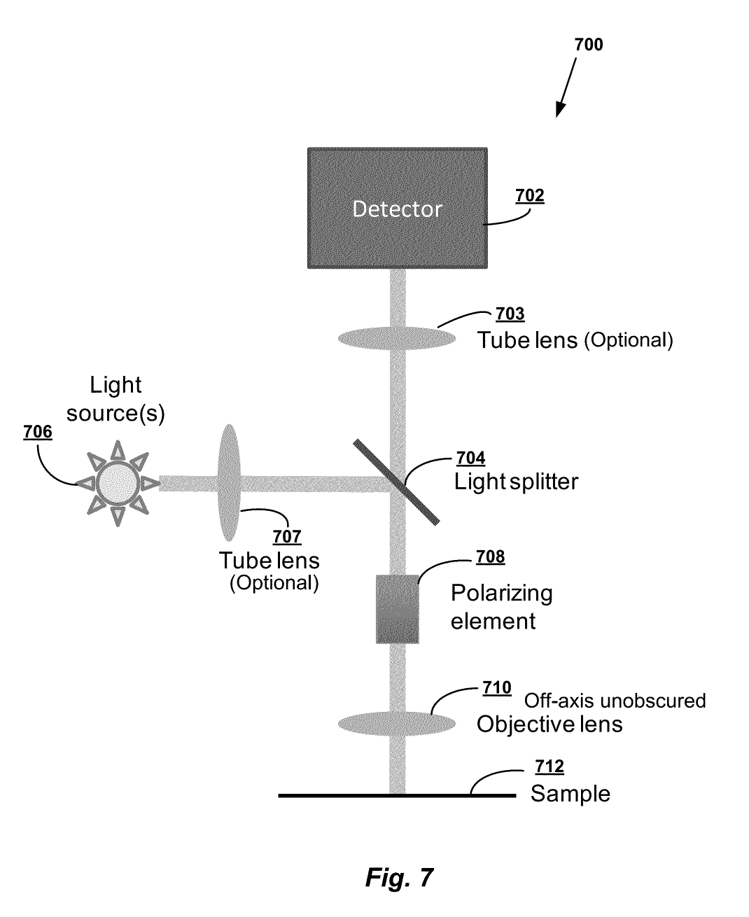

As shown, the ellipsometer includes an additional light source and detector (e.g. spectrometer), along with various other counterparts (e.g. polarizer, etc.). It should be noted that the ellipsometer may be of any well known configuration, or alternatively may be of the configuration described below with respect to FIG. 7. In the embodiment shown, the additional light source of the ellipsometer projects light to contact a same area of the fabricated component as the transformed light of the reflectometer (i.e. both spots are co-located (parcentral and parfocal)). While the reflectometer projects the transformed light onto the fabricated component at a normal incidence, the ellipsometer projects light onto the fabricated component at an oblique incidence.

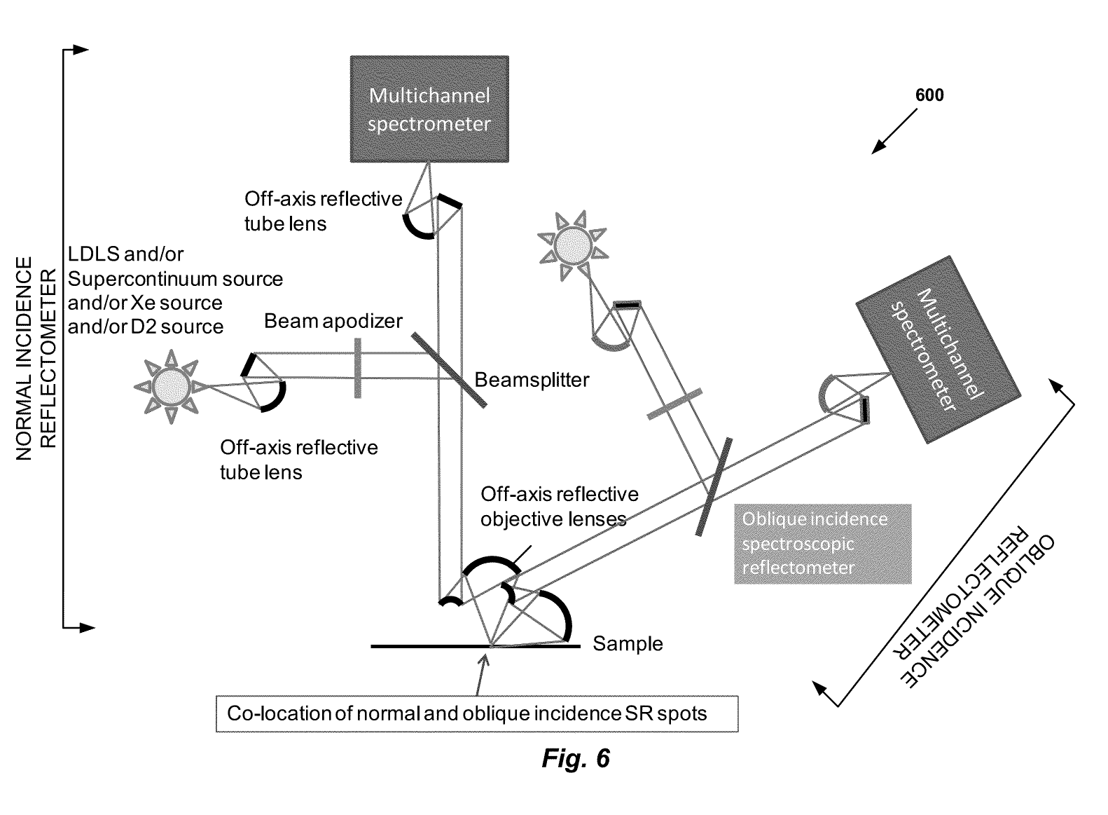

FIG. 6 illustrates a metrology system 600 comprising a first infinite conjugate reflectometer with a beam apodizer and off-axis unobscured objective lens for normal incidence, and a second infinite conjugate reflectometer with an off-axis unobscured objective lens for oblique incidence, in accordance with still yet another embodiment. Again, it should be noted that the definitions above may equally apply to the following description.

The metrology system 600 comprises a first infinite conjugate reflectometer portion which is configured as described above with respect to FIG. 3 (or which may take any of the other configurations described above). This first infinite conjugate reflectometer is a normal-incidence reflectometer as described above.

Also included is a second infinite conjugate reflectometer which is configured as described above with respect to FIG. 3 (or which may take any of the other configurations described above). This second infinite conjugate reflectometer is an oblique-incidence reflectometer that is co-located with the first infinite conjugate reflectometer. As shown, the oblique-incidence reflectometer projects light to contact a same area of the fabricated component as the transformed light of the normal-incidence reflectometer.

FIG. 7 illustrates an ellipsometer 700 comprising an off-axis unobscured objective lens, in accordance with an embodiment. Again, it should be noted that the definitions above may equally apply to the following description.

As shown, the ellipsometer 700 includes one or more light sources 706 for projecting light (e.g. broadband light). The ellipsometer 700 additionally includes a light splitter 704 for receiving the light projected by the light source 706, transforming at least one aspect of the light, and projecting the light once transformed.

In the embodiment shown, the light splitter 704 can transform the light by changing a direction of the light. For example, the light splitter 704 can receive the light and then project the same in a direction that provides normal incidence with a fabricated component 712 to which contact is to be made. In any case, the light splitter 704 is utilized to transform at least one aspect of the light and then project the transformed light toward an off-axis unobscured objective lens 710 described below. It should be noted that the light splitter 704 may be an optional component of the ellipsometer 700, and may be included for example to provide normal incidence.

Strictly as an option, the ellipsometer 700 may include a tube lens 707 situated between the light source 706 and the light splitter 704 along the light path, and through which the light projected from the light source 706 passes to reach the light splitter 704. In one embodiment, the tube lens 707 may have an off-axis unobscured aspheric reflective configuration to minimize chromatic aberrations.

In addition, the ellipsometer 700 includes a polarizing element 708 through which the (e.g. transformed) light passes to polarize the light. In one embodiment, the polarizing element 708 may be a polarizer. Further, the ellipsometer 700 includes an off-axis unobscured objective lens 710 through which the polarized light passes to contact a fabricated component 712 (shown as sample). The off-axis unobscured objective lens 710 may further be aspheric. As noted above, the polarized light may pass through the off-axis unobscured objective lens 710 to contact the fabricated component 712 at a normal incidence.

As also shown, the ellipsometer 700 includes a detector 702 for detecting a result of the polarized light contacting the fabricated component 712. The result may indicate whether or not the polarized light (or parts thereof) do in fact contact the fabricated component 712, or any other information related to contact between the light and the fabricated component 712. For example, the detector 702 may be a spectrometer which performs measurements based on information collected from the contact between the polarized light and the fabricated component 712, in which case the reflectometer 700 may be a spectroscopic ellipsometer.

Optionally, the ellipsometer 700 may include a tube lens 703 through which the detector detects the result of contact between the polarized light and the fabricated component 712. As shown, this optional tube lens 703 may be situated between the detector 702 and the light splitter 704 along the light path, to pass any result of the contact between the polarized light and the fabricated component 712 through the tube lens 703. In one embodiment, the tube lens 703 may have an off-axis unobscured aspheric reflective configuration, similar to the tube lens 707 described above.

To this end, in use, the ellipsometer 700 described above may operate to: (1) project light from the light source 706, optionally (2) receive the light projected by the light source 706 at the light splitter 704, optionally (3) transform, by the light splitter 704, at least one aspect of the light, optionally (4) project, by the light splitter 704, the light once transformed, (5) pass the light through a polarizing element 708, (6) pass the polarized light through the off-axis unobscured objective lens 710 to contact the fabricated component 712, and (7) detect, by the detector 702, a result of the polarized light contacting the fabricated component 712. Of course, it should be noted that the sequence of these operations is not so limited, such as for example when the ellipsometer 700 includes the tube lenses 703 and 707 along the light path.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. An inspection system, comprising:
a reflectometer including:
a light source for projecting light;
a light splitter for receiving the light projected by the light source, transforming at least one aspect of the light, and projecting the light once transformed;
an off-axis unobscured objective lens through which the transformed light passes to contact a fabricated component; and
a detector for detecting a result of the transformed light contacting the fabricated component.

2. The inspection system of claim 1, the reflectometer further including a tube lens through which the detector detects the result.

3. The inspection system of claim 2, wherein the tube lens has an off-axis unobscured aspheric reflective configuration.

4. The inspection system of claim 1, the reflectometer further including a tube lens situated between the light source and the light splitter, and through which the light projected from the light source passes to reach the light splitter.

5. The inspection system of claim 4, wherein the tube lens has an off-axis unobscured aspheric reflective configuration.

6. The inspection system of claim 1, wherein the light source an ultra-high-brightness light source, and includes at least one of a laser-driven plasma source, a radio frequency (RF)-driven plasma source, and a supercontinuum laser source.

7. The inspection system of claim 1, wherein the light projected from the light source is broadband light.

8. The inspection system of claim 1, wherein the transformed light passes through the off-axis unobscured objective lens to contact the fabricated component at a normal incidence.

9. The inspection system of claim 1, wherein the off-axis unobscured objective lens is aspheric.

10. The inspection system of claim 1, wherein an area of contact between the transformed light and the fabricated component is 15 by 15 micron or smaller.

11. The inspection system of claim 1, wherein an area of contact between the transformed light and the fabricated component is 10 by 10 micron or smaller.

12. The inspection system of claim 1, the reflectometer further including an apodizer situated between the light source and the light splitter, and through which the light projected from the light source passes to reach the light splitter.

13. The inspection system of claim 1, wherein the reflectometer is co-located with an ellipsometer.

14. The inspection system of claim 13, wherein the ellipsometer projects light to contact a same area of the fabricated component as the transformed light of the reflectometer.

15. The inspection system of claim 1, wherein the reflectometer is a normal-incidence reflectometer which is co-located with an oblique-incidence reflectometer.

16. The inspection system of claim 15, wherein the oblique-incidence reflectometer projects light to contact a same area of the fabricated component as the transformed light of the normal-incidence reflectometer.

17. The inspection system of claim 16, wherein the oblique-incidence reflectometer comprises:
a second light source for projecting light;
a second light splitter for receiving the light projected by the second light source, transforming at least one aspect of the light, and projecting the light once transformed;
a second off-axis unobscured objective lens through which the transformed light passes to contact the fabricated component; and
a second detector for detecting a result of the transformed light contacting the fabricated component.

18. The inspection system of claim 1, wherein the reflectometer is a sensor used in an integrated optical metrology tool.

19. The inspection system of claim 1, wherein the inspection system is a metrology system.

20. A method, comprising:
projecting light from a light source of a reflectometer;
receiving the light projected by the light source at a light splitter;
transforming, by the light splitter, at least one aspect of the light;
projecting, by the light splitter, the light once transformed;
passing the transformed light through an off-axis unobscured objective lens to contact a fabricated component; and
detecting, by a detector, a result of the transformed light contacting the fabricated component.

21. An inspection system, comprising:
an ellipsometer including:
a light source for projecting light;
a polarizing element through which the light passes to polarize the light;
an off-axis unobscured objective lens through which the polarized light passes to contact a fabricated component; and
a detector for detecting a result of the polarized light contacting the fabricated component.
